(19) United States
(12) Patent Application Publication
(10) Pub. No.: US 2025/0224903 A1
(43) Pub. Date: Jul. 10, 2025

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: SATOKI WATARIUCHI, Tokyo (JP)

(21) Appl. No.: 18/967,416

(22) Filed: Dec. 3, 2024

(30) Foreign Application Priority Data
Jan. 10, 2024 (JP) 2024-001755

(51) Int. Cl. G06F 3/12

(52) U.S. Cl. CPC G06F 3/1204; G06F 3/1258

(57) ABSTRACT

An image forming apparatus executing a job relating to image processing includes a setting unit configured to set a UI screen corresponding to an application for executing the job so that the UI screen is in a state of a type selected by a user from a plurality of types, a management unit configured to, in a case where the user changes a setting value on the UI screen in the state of the set type to execute the job, store the changed setting value associated with information on the set type, and a control unit configured to, in a case where a currently set type is changed to another type based on selection by the user, display the UI screen in a state of the other type using a setting value associated with information on the other type out of setting values stored by the management unit.

### BACKGROUND

### Field of the Invention

The present disclosure relates to job setting for an image forming apparatus.

### Description of the Related Art

Image forming apparatuses capable of executing jobs such as copying, scanning, and faxing are known. In the case of causing an image forming apparatus to execute a job, a user may intend to execute the job with the same setting value as a previous setting value (see Japanese Patent Laid-Open No. 2017-60064).

The above technique discloses a method for authenticating a user who is to log in and saving a job setting value for each user.

In a case where a plurality of users repeatedly execute jobs with the same setting value, such as routine tasks, the method in the above technique requires that the same setting value be set for each user, which is time-consuming.

Thus, a method can be considered in which, in a case where a job setting value is changed, the job setting value is saved without being associated with a user.

However, there may be a plurality of routine tasks with different job setting values, and in this case, in a case where a user changes a job setting value to perform another routine task, the changed setting value is saved, which requires the user to manually change the setting value every time the user starts another routine task, which increases user's work.

The object of the present disclosure is to save user's work at the time of job setting.

### SUMMARY

An image forming apparatus according to the present disclosure is an image forming apparatus executing a job relating to image processing, the image forming apparatus including a setting unit configured to set a UI screen corresponding to an application for executing the job so that the UI screen is in a state of a type selected by a user from a plurality of types, a management unit configured to, in a case where the user changes a setting value on the UI screen in the state of the set type to execute the job, store the changed setting value associated with information on the set type, and a control unit configured to, in a case where a currently set type is changed to another type based on selection by the user, display the UI screen in a state of the other type using a setting value associated with information on the other type out of setting values stored by the management unit.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an image forming apparatus;

FIG. 2 is a block diagram showing a functional configuration of the image forming apparatus;

FIGS. 3A and 3B are diagrams showing examples of a job execution screen;

FIG. 4 is a flowchart showing processing in the image forming apparatus;

FIG. 5 is a diagram for explaining a setting value stored for each slot number;

FIG. 6 is a diagram showing an example of the job execution screen; and

FIG. 7 is a flowchart showing processing in the image forming apparatus.

### DESCRIPTION OF THE EMBODIMENTS

Hereinafter, exemplary descriptions will be given of embodiments of a technique according to the present disclosure with reference to the drawings. Components described in the following embodiments are merely examples, and are not intended to limit the scope of the technique according to the present disclosure only thereto.

### First Embodiment

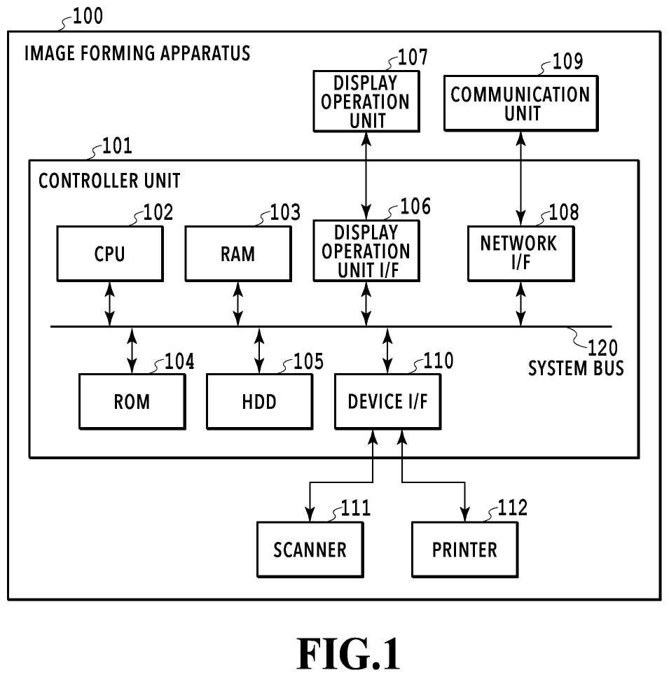

FIG. 1 is a block diagram showing the hardware configuration of an image forming apparatus 100 according to the present embodiment. The image forming apparatus 100 includes a controller unit 101, a scanner 111, a printer 112, a display operation unit 107, and a communication unit 109.

The controller unit 101 controls the overall operation of the image forming apparatus 100. Specifically, the controller unit 101 controls the scanner 111, the printer 112, the display operation unit 107, and the communication unit 109. The controller unit 101 includes a CPU 102, a RAM 103, a ROM 104, an HDD 105, a display operation unit I/F 106, a network I/F 108, and a device I/F 110, which are connected via a system bus 120.

The RAM 103 is a system work memory for the CPU 102 to operate, and an image memory for temporarily storing image data. The RAM 103 also stores programs such as an operating system, system software, and application software, or data. The RAM 103 also stores data on a scanned image obtained by the scanner 111 reading a document, and stores print data received by the controller unit 101 via a network. The ROM 104 stores a system boot program. The hard disk drive (HDD) 105 is a nonvolatile storage unit that stores an operating system, system software, application software, print data, setting data, and the like. The CPU 102 reads out the program stored in the ROM 104 into the RAM 103 and executes the program to perform various kinds of control for executing jobs to be described later.

The display operation unit I/F 106 is an interface unit with the display operation unit 107. The display operation unit 107 includes, for example, a liquid crystal display unit (touch panel) having a touch panel function, physical buttons, and the like. For example, the physical buttons include a home button for returning to a home screen.

An operation performed by a user on the display operation unit 107 is converted into a signal by the display operation unit I/F 106 and is received by the CPU 102. For example, a position touched by a user on the touch panel of the display operation unit 107 is detected, and a signal indicating information on the position is generated. The CPU 102 can identify the position touched by the user on the touch panel by analyzing the signal. Further, the display operation unit I/F 106 outputs information on a screen displayed on the touch panel of the display operation unit 107 to the display operation unit 107.

The network I/F 108 is connected to the communication unit 109 and performs various kinds of control of communication with an external device (not shown).

The device I/F 110 connects the printer 112 to the controller unit 101. The printer 112 has a mechanism for printing an image shown by image data on a print medium. The device I/F 110 also connects the scanner 111 to the controller unit 101. The scanner 111 reads a document and generates scanned image data showing the contents of the read document. The generated scanned image data is input to the controller unit 101 via the device I/F 110.

Incidentally, the HDD 105 may be included in an external device that is a device different from the image forming apparatus 100. In this case, the CPU 102 stores data in the HDD 105 of the external device via the communication unit 109, and also acquires data from the HDD 105 of the external device via the communication unit 109.

In a case where an instruction to execute a copy function is received from a user, the controller unit 101 acquires scanned image data on a document by causing the scanner 111 to read the document, and controls the printer 112 to print a scanned image on a sheet. In a case where an instruction to execute a scan transmission function is received from a user, the controller unit 101 acquires scanned image data on a document by causing the scanner 111 to read the document. The controller unit 101 then converts the scanned image data into code data and transmits the data to an external device (not shown) via the communication unit 109. A series of processes based on an instruction to execute each function, such as the copy function and the scan transmission function, is referred to as job. The image forming apparatus 100 also functions as a job processing apparatus that executes jobs corresponding to respective functions.

The functions corresponding to the jobs executed by the image forming apparatus 100 are not limited to the copy function and the scan function.

### Functional Configuration

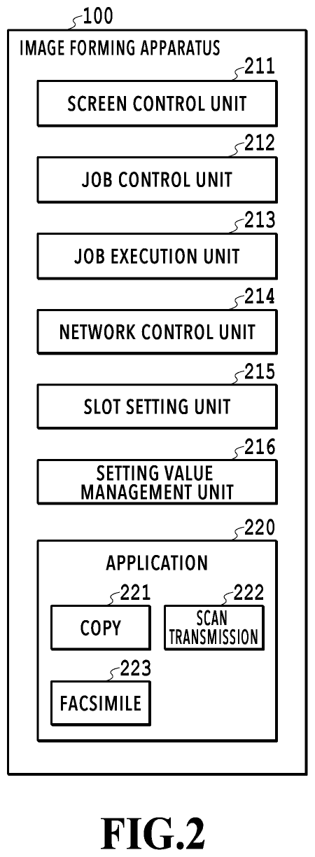

FIG. 2 is a block diagram showing the functional configuration of the image forming apparatus 100 according to the present embodiment.

The image forming apparatus 100 includes a plurality of applications 220 for implementing respective functions, and an application selected by a user from the plurality of applications 220 is activated and operates. The plurality of applications 220 include a copy application 221 that executes a job corresponding to the copy function described above, a scan transmission application 222 that executes a job corresponding to the scan transmission function, a facsimile application 223, and the like. The scan transmission application 222 is an application for executing the job of transmitting scanned image data obtained by scanning a document with the scanner 111 to an external device. The plurality of applications 220 shown in FIG. 2 are examples of an application that executes a job relating to image processing that operates on the image forming apparatus 100.

The image forming apparatus 100 also includes a screen control unit 211, a job control unit 212, a job execution unit 213, a network control unit 214, a slot setting unit 215, and a setting value management unit 216.

The screen control unit 211 performs display control to display a screen provided by an application in operation on the touch panel of the display operation unit 107. Further, the screen control unit 211 identifies a position touched by a user on the touch panel of the display operation unit 107 based on a signal from the display operation unit 107. The screen control unit 211 then instructs the application in operation to execute processing associated with an operation button or the like that corresponds to the position touched by the user.

The job control unit 212 automatically performs job setting for the application in operation. For example, the job setting is made by storing, in the RAM 103, a setting value stored in the HDD 105. In a case where it is determined that the job execution button has been pressed, the job execution unit 213 acquires the setting value stored in the RAM 103 and causes the application in operation to execute a job based on the acquired setting value. For example, in a case where the application in operation is a scan transmission application, in a case where an instruction to execute a job is given, the job control unit 212 causes the scanner 111 to read a document placed on a platen glass through the device I/F 110 to generate scanned image data. The network control unit 214 controls the communication unit 109 through the network I/F 108 to transmit data to an external device.

The slot setting unit 215 sets a slot number to be described later. The setting value management unit 216 stores a setting value in a nonvolatile storage unit in association with a slot number. In a case where a user changes the setting value to execute a job, the setting value management unit 216 automatically updates the setting value associated with the currently set slot number to the changed setting value.

The function of each block in FIG. 2 is implemented by the CPU 102 reading a predetermined program stored in the ROM 104 or HDD 105 into the RAM 103 and executing the program, but the present disclosure is not limited to this. Additionally, for example, hardware such as a graphics processing unit (GPU) or a field programmable gate array (FPGA) for speeding up computing may be used. Each function may be implemented with the cooperation between software and hardware such as a dedicated IC, or a portion or all of the functions may be implemented only by hardware. Incidentally, the functional units 211 to 216 in FIG. 2 may be configured to be included in the respective applications 220.

### Regarding Slot

In the present embodiment, the applications manage the values (setting values) of respective setting items of a job for each unit referred to as “slot.” Each unit for managing the setting values is also referred to as “setting slot.” It is assumed, for example, that the scan transmission application 222 manages a job setting value by associating the setting value with one of the four slot numbers “1,” “2,” “3,” and “4.” The slot number selected by a user is also managed for each application.

Setting values associated with respective slot numbers and the slot number lastly selected by the user are controlled to be stored in a nonvolatile storage unit. The expression “stored in a nonvolatile storage unit” is defined as being held with the same contents unless the user gives an explicit change instruction. For example, a setting value associated with a certain slot number is controlled to be stored in the HDD 105, which is a nonvolatile storage unit, until the user gives an explicit instruction to change the setting value. Thus, for example, in a case where the image forming apparatus 100 is powered on again, values before the power is turned on again are held as setting values associated with respective slot numbers and a slot number.

### Regarding Job Execution Screen

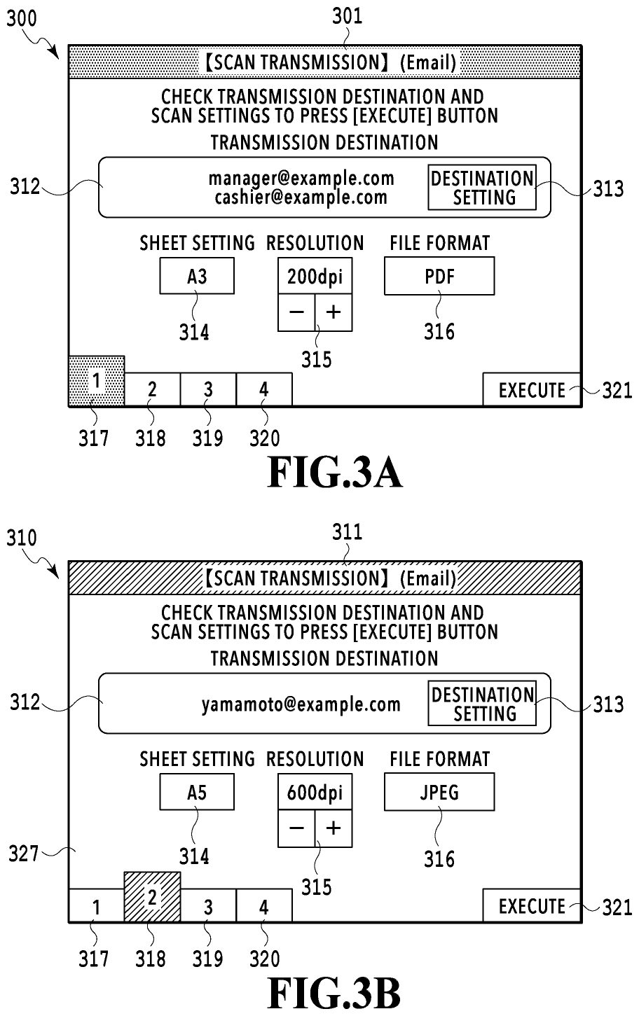

FIGS. 3A and 3B are diagrams showing examples of a job execution screen, which is a user interface screen (UI screen) displayed during operation of an application activated via a home screen (not shown). FIGS. 3A and 3B show, as an example, a job execution screen displayed during operation of the scan transmission application 222. Through the job execution screen shown in FIGS. 3A and 3B, a user can give an instruction to set (change) the setting value of each setting item during execution of a job in the scan transmission application 222, and execute the job.

The job execution screen according to the present embodiment includes tabs 317 to 320 for a user to select a slot number. In a case where any one of the tabs 317 to 320 is pressed, a job setting screen corresponding to a slot number indicated by the pressed tab is displayed.

FIG. 3A is a diagram showing a job execution screen of the scan transmission application displayed in a case where the slot number is set to “1.” The job execution screen 310 includes a plurality of operation buttons. For example, the plurality of operation buttons are a job execution button 321 and setting buttons 313 to 316. The screen control unit 211 identifies an operation button pressed by a user, and the application performs processing corresponding to the identified operation button.

The setting buttons 313 to 316 are operation buttons for a user to make job setting.

By pressing the setting buttons 313 to 316, the user can change the setting values of respective setting items during job execution. The job execution screens 300 and 310 in FIGS. 3A and 3B include the following job setting buttons: destination setting button 313, sheet size setting button 314, resolution setting button 315, and file format setting button 316.

The destination setting button 313 is an operation button for setting a destination by, for example, adding, deleting, or modifying an address to which scanned image data is to be transmitted. In a case where the destination setting button 313 is pressed, a screen (not shown) for selecting a transmission destination is displayed. In a case where an address is selected on that screen, the scan transmission application 222 sets the selected address as a transmission destination. The set address is displayed in a transmission destination display area 312.

The sheet size setting button 314 is an operation button for setting a size in a case where the scanner 111 reads a document. In a case where the sheet size setting button 314 is pressed, a screen (not shown) including options for reading sizes is displayed, and a user can set a desired reading size on the screen.

The resolution setting button 315 is an operation button for setting a resolution in a case where the scanner 111 reads a document and converts the document into scanned image data. The resolution setting button 315 includes a “+” button for increasing the resolution and a “−” button for decreasing the resolution.

A user can set a desired resolution by operating the “+” button and the “−” button.

The file format setting button 316 is an operation button for changing the file format of scanned image data obtained by the scanner 111 reading a document. In a case where the file format setting button 316 is pressed, a screen (not shown) is displayed, and a user can set the file format to a desired file format on the screen.

The job execution button 321 is an operation button for instructing an application in operation to execute a job based on a setting value set via the job execution screens 300 and 310. In a case where the job execution button 321 displayed on the job execution screens 300 and 310 of the scan transmission application 222 is pressed, a scan transmission job is executed.

The tabs 317 to 320 are buttons for a user to select the above-mentioned slot number. The tab 317 is a button for changing the slot number to “1”. The tab 318 is a button for changing the slot number to “2”, the tab 319 is a button for changing the slot number to “3”, and the tab 320 is a button for changing the slot number to “4”. In the HDD 105, a currently set slot number is stored.

In the present embodiment, the slot number is set to a changed slot number in response to presses on the tabs 317 to 320 on the job execution screens 300 and 310 displayed on the touch panel of the display operation unit 107. A method for changing the slot number may be a method other than the method using tabs. For example, the slot number may be displayed in a pull-down menu instead of tabs. Alternatively, a physical button for changing the slot number may be included in the display operation unit 107 to change the slot number in response to a press on the button.

FIG. 3A shows a job execution screen in a case where the slot number is set to “1.” Thus, in FIG. 3A, the tab 317 corresponding to the set slot “1” is controlled so as to be displayed more emphasized than the other tabs 318 to 320.

The title display area 301 is an area that displays the name of an application in operation.

The title display area 301 is display-controlled so that the background of the title display area 301 and the background of the tab 317 corresponding to the slot number “1” have the same color or pattern so that a user can recognize that the set slot number is “1”. Such display allows the user to recognize the currently set slot number.

FIG. 3B is a diagram showing the job execution screen 310 of the scan transmission application displayed in a case where the slot number is set to “2.” Thus, in FIG. 3B, the tab 318 corresponding to the set slot “2” is controlled so as to be displayed more emphasized than the other tabs 317, 319, and 320. The title display area 311 in FIG. 3B is display-controlled so as to have a background that matches the background of the tab 318 whose currently set slot number is “2.”

Further, the background of the title display area 311 in FIG. 3B is display-controlled to be different from the background of the title display area 301 in FIG. 3A so that a user can recognize that the set slot number is “2”. Thus, in the present embodiment, the background of the title display area of the job execution screen is display-controlled to be different for each currently set slot number. That is, in the present embodiment, a job execution screen provided by an application is controlled so that a plurality of types of job execution screens, each with a different background for each slot number, are displayed.

Incidentally, an expression method for causing a user to recognize the currently set slot number is not limited to this. For example, the overall color of the job execution screens 300 and 310 may be changed according to the currently set slot number. Alternatively, different character strings may be displayed in the title display areas 301 and 311 for each currently set slot number.

In the present embodiment, the job execution screens 300 and 310 are not provided with a button for resetting a setting value to an initial value. Thus, the following description will be given on the assumption that the image forming apparatus is one in which in a case where the setting values of a group of setting items on the job execution screen 310 are changed, the setting values are maintained until the setting values are changed next.

### Flowchart

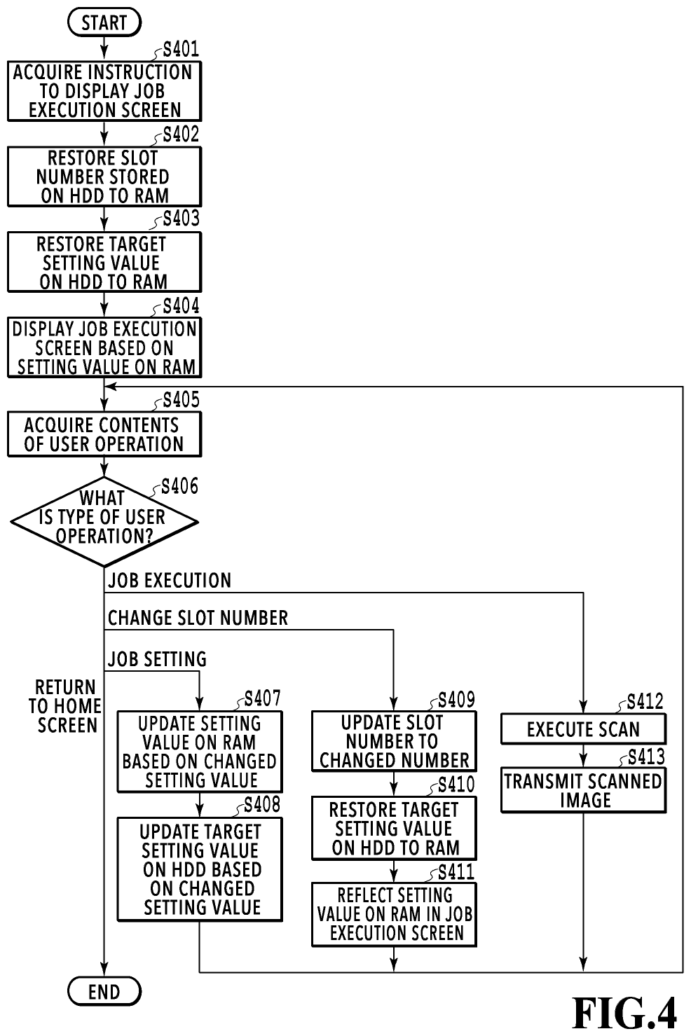

FIG. 4 is a flowchart for explaining job setting value management executed by the image forming apparatus 100 in the present embodiment. A series of steps shown in the flowchart in FIG. 4 is performed by the CPU 102 developing, in the RAM 103. a program code stored in the ROM 104 or HDD 105 and executing the program code. Further, a portion or all of the functions of the steps in FIG. 4 may be implemented by hardware such as an ASIC or electronic circuit. It should be noted that the symbol “S” in the description of each step refers to an operation (step) in the flowchart, and the same applies to the subsequent flowcharts.

FIG. 4 shows a flow of job setting value management in a case where the scan transmission application 222 of the plurality of applications is activated. The scan transmission application 222 is one example, and the same process as that shown in the flowchart in FIG. 4 is also performed in a case where another application such as the copy application or the fax transmission application is activated.

It should be noted that the image forming apparatus 100 according to the present embodiment is an image forming apparatus that does not perform user authentication. Thus, a user can operate the image forming apparatus 100 without logging in.

A process shown in the flowchart in FIG. 4 starts in response to a user designating the scan transmission application 222 on a home screen (not shown) and the screen control unit 211 instructing the scan transmission application 222 to display a job execution screen.

In S401, the scan transmission application 222 acquires an instruction to display a job execution screen from the screen control unit 211.

In S402, the scan transmission application 222 acquires a slot number stored in the HDD 105, and loads the acquired slot number into the RAM 103 so that the acquired slot number is set.

In S403, the scan transmission application 222 acquires a setting value in association with the slot number stored in the RAM 103 from among setting values for the job of the scan transmission application 222 stored in the HDD 105. The acquired setting value is then stored in the RAM 103. In a case where no setting values for the scan transmission application 222 are stored in the HDD 105, an initial setting value is stored in the RAM 103.

In the present embodiment, setting values for the scan transmission application 222 associated with respective slot numbers are stored in the HDD 105. For example, a file for each slot number, including a setting value set by a user in a case where a corresponding slot number has been set, is stored in the HDD 105. In S403, the file corresponding to the slot number stored in the RAM 103 is acquired from the HDD 105, and the acquired file is stored in the RAM 103, so that a setting value corresponding to the currently set slot number is restored to the RAM. This method is an example of a method for managing a setting value for each slot number, and another method may be used. For example, setting values may be managed in one file by managing the setting values associated with a plurality of slot numbers so that the setting values can be distinguished within one file. Alternatively, a setting value associated with each slot number may be managed using software such as a database.

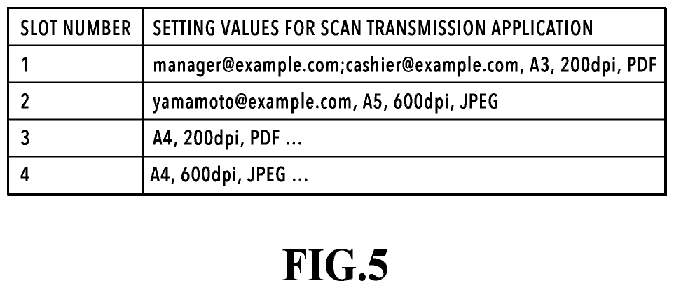

FIG. 5 is a diagram for explaining setting values for the scan transmission application 222 stored in the HDD 105. Each row of the table in FIG. 5 shows the setting values of a group of setting items associated with a slot number stored in separate files in the HDD 105.

“A group of setting items” refers to a group of setting items for a job executed by an application in operation. For example, in a case where the application in operation is the scan transmission application 222, the group of setting items refers to a group of setting items: “destination,” “sheet size,” “resolution,” and “file format.” It should be noted that setting values stored in the HDD 105 do not have to be all setting values that can be set on the job execution screens 300 and 310. For example, the “group of setting items” does not have to include a “destination” item, and a setting value for the “destination” does not have to be stored in the HDD 105.

In S404, the scan transmission application 222 displays a job execution screen reflecting the setting value stored in the RAM 103 on the touch panel of the display operation unit 107.

For example, in a case where the scan transmission application 222 is exited with the slot number “1” selected, the slot number “1” is stored in the HDD 105. It is also assumed that setting values are stored in the HDD 105 as shown in FIG. 5. In this state, in a case where the scan transmission application 222 is activated and the process shown in the flowchart in FIG. 4 is started again, the slot number “1” is restored to the RAM 103 in S402. In S403, a setting value associated with the slot number “1” from among the setting values shown in FIG. 5 is restored to the RAM 103. As a result, in S404, the job execution screen 300 reflecting the setting value associated with the slot number “1” is displayed as shown in FIG. 3A.

In S405, the scan transmission application 222 waits for a user to operate the display operation unit 107, and in a case where the user operates the display operation unit 107, the scan transmission application 222 acquires the contents of the operation. In a case where the user presses an operation button on the job execution screens 300 and 310 displayed on the touch panel of the display operation unit 107, the scan transmission application 222 acquires information on the pressed operation button via the screen control unit 211. Further, in a case where a home button (not shown) for returning to a home screen included in the display operation unit 107 is pressed, the scan transmission application 222 acquires information that the home button has been pressed.

In S406, the scan transmission application 222 switches between steps in response to the user's operation of the display operation unit 107.

If the type of acquired user operation is determined to be “JOB SETTING” in S406, the scan transmission application 222 executes S407 and S408. “JOB SETTING” refers to, for example, an operation to press any of the setting buttons 313 to 316 on the job execution screens 300 and 310 in FIGS. 3A and 3B to change a setting item relating to a scan transmission job, such as addition or deletion of a transmission destination, resolution setting, and the like.

In S407, the scan transmission application 222 acquires the changed setting value of a setting item changed by the user this time. The scan transmission application 222 then updates the setting value of the setting item changed this time among the setting values stored in the RAM 103 so that the setting value of the setting item changed this time becomes the changed setting value.

In S408, the scan transmission application 222 updates a setting value stored in the HDD 105 and associated with the currently set slot number to the changed setting value.

For example, in a case where the user changes the setting value of any of the setting items via the job execution screen 300 with the slot number set to “1,” a setting value included in a file corresponding to the slot “1” in the HDD 105 is updated to the changed setting value. For example, in a case where the contents of the “sheet size” are changed from “A4” to “B4” on the job execution screen 300 in FIG. 3A, “B4” is acquired as a changed setting value.

The setting value of the “sheet size” associated with the slot number “1” stored in the HDD 105 is then updated to “B4” after the change. The scan transmission application 222 then returns the process to S406.

As described above, in a case where a setting value is changed by a user operation, the setting value stored in the HDD 105 in association with the currently set slot number is updated without an instruction from a user to store the setting value.

Next, if it is determined in S406 that the type of acquired user operation is “CHANGE SLOT NUMBER,” the scan transmission application 222 executes S409 to S411. A user operation whose type is “CHANGE SLOT NUMBER” corresponds to an operation to press any tab among the tabs 317 to 320 other than the tab corresponding to the currently set slot number.

In S409, the scan transmission application 222 updates the slot number stored in the HDD 105 and the RAM 103 so that the slot number corresponding to the tab selected by the user from among the tabs 317 to 320 is set.

In S410, the scan transmission application 222 acquires the setting value in association with the changed slot number stored in the RAM 103 from among the setting values for the scan transmission application 222 stored in the HDD 105. The acquired setting value is then stored in the RAM 103, so that the setting value associated with the changed slot number is restored onto the RAM 103.

In step S411, the scan transmission application 222 reflects the setting values stored in the RAM 103 on the job execution screen displayed on the touch panel.

For example, it is assumed that the operation acquired in S405 is an operation to press the tab 318 corresponding to the slot number “2.” It is also assumed that the setting value corresponding to the slot number “2” is stored in the HDD 105 as shown in FIG. 5. In this case, in S411, display control is performed so that the job execution screen 310 in the state of FIG. 3B is displayed.

As described above, in a case where a user performs an operation to change a slot number, a job execution screen that reflects a setting value stored in association with the changed slot number in the HDD 105 is displayed. Thus, even in a case where the user temporarily changes the slot number to “1” to change the setting value and executes a job, in a case where the user changes the slot number back to “2,” the setting value previously set by the user with the slot number being “2” is restored to the job execution screen 310.

Next, in a case where it is determined in S406 that the type of user operation is “JOB EXECUTION,” the scan transmission application 222 executes S412 and S413. A user operation whose type is “JOB EXECUTION” is an operation to execute a job and is an operation corresponding to a press on the job execution button 321.

In S412, the scan transmission application 222 generates scanned image data on a document by causing the scanner 111 to scan the document via the job control unit 212 in accordance with the setting values stored in the RAM 103. During job execution, the scan transmission application 222 displays a dialog (not shown) on the foreground of the job execution screens 300 and 310 to notify the user that scanning is being executed.

In S413, the scan transmission application 222 transmits the scanned image data to an external device corresponding to the setting value (address) of the setting item “destination” stored in the RAM 103 through the network control unit 214. The scan transmission application 222 displays a dialog (not shown) on the foreground of the job execution screens 300 and 310 to notify the user that transmission processing is in progress until transmission of the scanned image data is completed.

Further, if the scan transmission application 222 determines in S407 that the type of acquired user operation is “RETURN TO HOME SCREEN,” the scan transmission application 222 ends the process shown in the present flowchart. A user operation whose type is “RETURN TO HOME SCREEN” is an operation to press a home button (not shown) on the display operation unit 107. If the screen returns to the home screen and the scan transmission application 222 is selected, the process shown in the flowchart in FIG. 4 is started again.

At this time, the set slot number is stored in the HDD 105 in a case where the “RETURN TO HOME SCREEN” button is pressed. Thus, in the process shown in the flowchart in FIG. 4 and started in a case where the user activates the scan transmission application 222, in S403, the setting value associated with the slot number stored in the HDD 105 is then stored in (restored to) the RAM 103. In S405, a job execution screen is displayed in which a setting item is automatically set in advance for each setting value associated with a slot number stored in the HDD 105. In this way, the setting value set at the time of the previous exit of the application is restored to the job execution screen.

In the present embodiment, a slot number and a setting value are stored in a nonvolatile storage unit, so that even in a case where the image forming apparatus 100 is powered off, a setting value previously set by a user can be restored to a job execution screen.

As described above, in the present embodiment, even in a case where a user who performs a task having a plurality of setting patterns for a job to be executed repeatedly uses the image forming apparatus, the need for resetting a setting value for each task is suppressed. In the present embodiment, since each time the user changes a setting value, the changed setting value is controlled so as to be automatically stored in the HDD 105, the user does not have to explicitly give an instruction to store the changed setting value. Thus, the method according to the present embodiment saves user's work. In this way, according to the present embodiment, it is possible to provide an image forming apparatus with increased usability.

### Second Embodiment

In the present embodiment, a description will be given of a method for managing job setting values different from the method in the first embodiment. The differences of the present embodiment from the first embodiment will be mainly described. The configuration and processing are the same as in the first embodiment unless otherwise specified.

### Regarding Temporary Slot

In the present embodiment, slot numbers include a number corresponding to a “temporary slot.” A job setting value changed by a user via a job execution screen with the “temporary slot” set is controlled to be stored in a volatile storage unit. The expression “to be stored in a volatile storage unit” is defined as the job setting value set by the user being reset to an initial value at a specific time. For example, a job setting value set by a user is controlled to be stored in the RAM 103 for the execution of the current job, but not to be stored in the HDD 105. Thus, in the present embodiment, in a case where the slot number is changed to a number corresponding to the “temporary slot,” control is made so that a job execution screen in which the item value of each setting item is an initial value is displayed.

In the first embodiment, a job setting value changed by a user via a job execution screen is controlled to be “stored in a nonvolatile storage unit” so as to be restored in the next job. However, in a case where a one-off job that is not planned to be executed again is executed, a user may intend to make job setting based on an initial value. Thus, in the present embodiment, a temporary slot is provided, so that the user can make job setting based on an initial value.

### Regarding Job Execution Screen

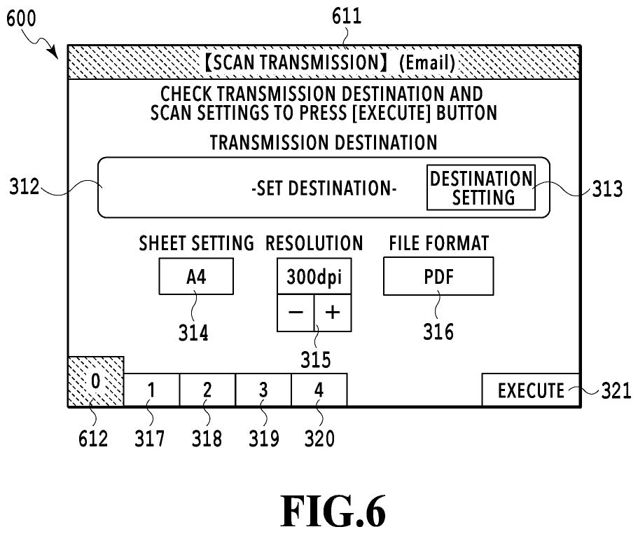

FIG. 6 is a diagram showing a job execution screen 600 according to the present embodiment. The same reference number is given to the same constituent as that of the job execution screen 300 according to the first embodiment, and the description thereof is omitted.

In the present embodiment, there is included a tab 612 for a user to select a temporary slot. As an example of a slot number indicating the temporary slot, “0” is shown, but a different number, character string, or graphic may be used.

FIG. 6 shows a job execution screen in a state where the slot number is set to “0.” Thus, in FIG. 6, the tab 612 corresponding to the set slot “0” is controlled so as to be displayed more emphasized than the other tabs 317 to 320.

The title display area 611 is controlled so as to have a background that allows a user to recognize that the set slot number is “0.” For example, the title display area 611 is display-controlled so that the background of the title display area 611 and the background of the tab 612 corresponding to the selected slot “0” have the same color or pattern. Such display makes it easy for a user to recognize the currently set slot number.

### Flowchart

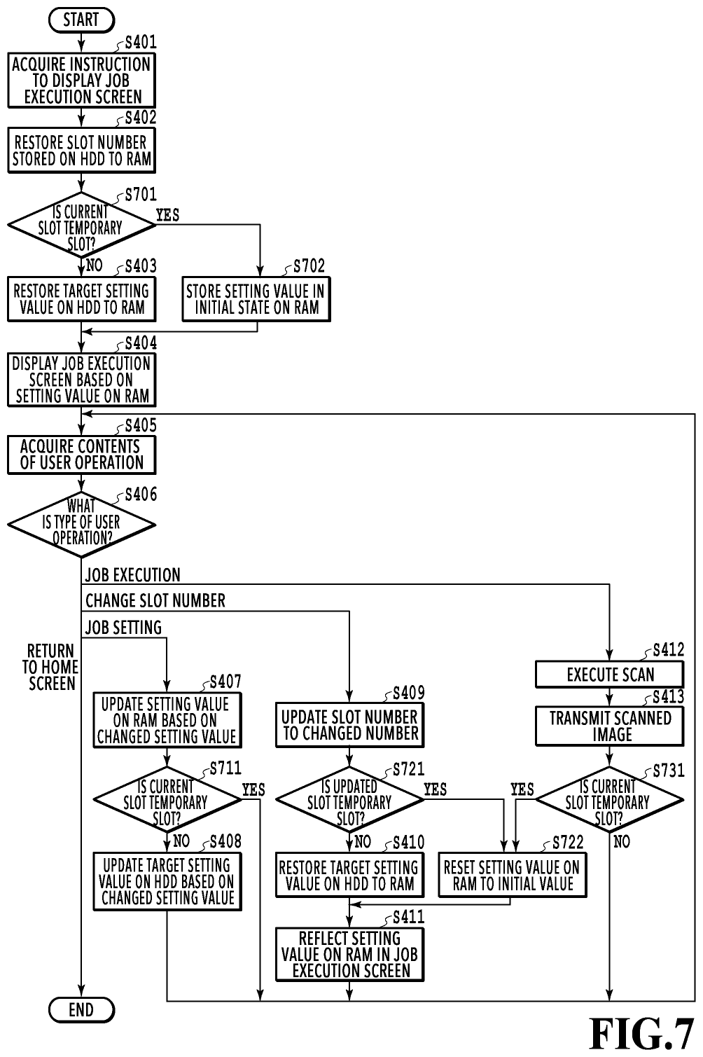

FIG. 7 is a flowchart for explaining the process of job setting value management executed by the image forming apparatus 100 in the present embodiment. A series of steps shown in the flowchart in FIG. 7 is performed by the CPU 102 developing, in the RAM 103, a program code stored in the ROM 104 or HDD 105 and executing the program code. Further, a portion or all of the functions of the steps in FIG. 7 may be implemented by hardware such as an ASIC or electronic circuit.

The flowchart in FIG. 7 is made by adding new steps to the flowchart in FIG. 4 according to the first embodiment. Thus, in the flowchart in FIG. 7, the same number is given to the same step as in the flowchart in FIG. 4. Therefore, in the description of the flowchart in FIG. 7, steps different from those in the flowchart in FIG. 4 will be described.

In the present embodiment, S701 is executed after S402. In S701, the scan transmission application 222 determines whether the currently set slot number is a “temporary slot” number in order to branch the process depending on whether a “temporary slot” is set. If the scan transmission application 222 determines that the currently set slot number is the “temporary slot” number (YES in S701), the process proceeds to S702.

In S702, the scan transmission application 222 stores an initial value in the RAM 103 as the setting value of a group of setting items for a job of the scan transmission application 222. The process then proceeds to S404, and the scan transmission application 222 performs control so that a job execution screen is displayed on which the initial value restored to the RAM 103 is displayed as a setting value of each setting item. The initial value is a value that indicates an initial state, and is, for example, a setting value at the time of shipment of the image forming apparatus 100.

On the other hand, if the scan transmission application 222 determines that the currently set slot number is not the “temporary slot” number (NO in S701), the process proceeds to S403 described with reference to FIG. 4.

Further, in S406, if the scan transmission application 222 determines that the type of acquired user operation is “JOB SETTING,” the process proceeds to step S407. In the present embodiment, the process proceeds to S711 after S407.

S711 is a step equivalent to S701, and the scan transmission application 222 determines whether the currently set slot number is the “temporary slot” number in order to branch the process depending on whether a “temporary slot” is set. If the scan transmission application 222 determines that the currently set slot number is not the “temporary slot” number (NO in S711), the process proceeds to S408. In S408, as described above, a setting value changed by a user is stored in the HDD 105 in association with the currently set slot number. After S408, the process then returns to S405.

On the other hand, if the scan transmission application 222 determines that the currently set slot number is the “temporary slot” number (YES in S711), since the setting value changed by the user is not stored in the HDD 105, S408 is skipped. The process then returns to S405.

As described above, in a case where the currently set slot is the slot described in the first embodiment, the setting value stored in the HDD 105 is updated to the setting value changed by the user's operation. On the other hand, the setting value changed by the user's operation in a state where the slot is set to the “temporary slot” is not stored in the HDD 105. Thus, in the “temporary slot,” it is possible to perform control so that the contents of job settings made by the user are stored in a volatile storage unit.

Further, in S406, if the scan transmission application 222 determines that the type of acquired user operation is “CHANGE SLOT NUMBER,” the process proceeds to S409. In the present embodiment, the process proceeds to S721 following S409.

In S721, the scan transmission application 222 determines whether the currently set slot number is a “temporary slot” number in order to branch the process depending on whether a changed slot is a “temporary slot.”

The currently set slot number is a slot number currently stored in the RAM 103. In S409, which is the previous step to the present step, the changed slot number selected by the user this time is stored in the RAM 103. Thus, in the S721, the currently set slot number refers to the changed slot number.

If the scan transmission application 222 determines that the currently set slot number is not the “temporary slot” number (NO in S721), the process proceeds to S410. In S410, as described above, the setting value of the changed slot number stored in the HDD 105 is restored to the RAM 103. The process then proceeds to S411. On the other hand, if the scan transmission application 222 determines that the currently set slot number is the “temporary slot” number (YES in S721), the process proceeds to S722.

In S722, the scan transmission application 222 resets the setting values of the group of setting items in the scan transmission application 222 stored in the RAM 103 to the initial values. The process then proceeds to S411. In a case where the process proceeds to S411, the scan transmission application 222 performs control so that a job execution screen is displayed with an initial value for each setting item, which is the setting value restored to the RAM 103. The process then returns to S405. In this way, in a case where a change to the “temporary slot” is made, S722 is performed instead of S412, thereby implementing control for resetting the setting values to the initial values.

Further, in S406, if the scan transmission application 222 determines that the type of acquired user operation is “JOB EXECUTION,” in the present embodiment, the scan transmission application 222 executes S731 following S412 and S413.

S731 is a step equivalent to S701, and the scan transmission application 222 determines whether the currently set slot number is a “temporary slot” number in order to branch the process depending on whether a “temporary slot” is set.

If the scan transmission application 222 determines that the currently set slot number is not the temporary slot” number (NO in S731), the process returns to S405, as in the first embodiment. On the other hand, if the scan transmission application 222 determines that the currently set slot number is the “temporary slot” number (YES in S731), the process proceeds to S722 and S411. That is, if the temporary slot is set, S722 is performed after the job execution is completed, thereby implementing control for resetting the setting values to the initial values.

As described above, according to the present embodiment, it is possible to suppress the need to set a setting value each time a job is executed repeatedly with the same settings, and to set a one-off job that is not planned to be repeated on the basis of an initial value. In other words, it is possible to save user's work at the time of job setting.

Therefore, according to the present embodiment, it is possible to provide an image forming apparatus with increased usability.

### Other Embodiments

The present disclosure can also be implemented by supplying a program that implements one or more of the functions according to the above-mentioned embodiments to a system or device via a network or storage medium, and causing one or more processors in the computer of the system or device to read and execute the program. The present disclosure can also be implemented by using a circuit (e.g., an ASIC) that implements one or more functions.

According to the present disclosure, it is possible to save user's work at the time of job setting.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001755, filed Jan. 10, 2024, which is hereby incorporated by reference herein in its entirety.

What is claimed is:

1. An image forming apparatus executing a job relating to image processing, the image forming apparatus comprising:
a setting unit configured to set a UI screen corresponding to an application for executing the job so that the UI screen is in a state of a type selected by a user from a plurality of types;
a management unit configured to, in a case where the user changes a setting value on the UI screen in the state of the set type to execute the job, store the changed setting value associated with information on the set type; and
a control unit configured to, in a case where a currently set type is changed to another type based on selection by the user, display the UI screen in a state of the other type using a setting value associated with information on the other type out of setting values stored by the management unit.

2. The image forming apparatus according to claim 1, wherein
the management unit stores the changed setting values associated with information on the plurality of types in a nonvolatile storage unit.

3. The image forming apparatus according to claim 2, further comprising
the nonvolatile storage unit.

4. The image forming apparatus according to claim 2, wherein
types set by the setting unit includes a first type different from the plurality of types, and
the management unit does not store, in the nonvolatile storage unit, a setting value changed by the user on the UI screen in a state of the first type to execute a job.

5. The image forming apparatus according to claim 4, wherein
the control unit, in a case where the UI screen in the state of the first type is displayed, displays the UI screen on which a setting value is an initial value.

6. The image forming apparatus according to claim 5, wherein
the control unit, in a case where the user gives an instruction to execute the job on the UI screen in the state of the first type, displays the UI screen on which the setting value is the initial value.

7. The image forming apparatus according to claim 1, further comprising
a display unit configured to display the UI screen.

8. The image forming apparatus according to claim 1, wherein
information indicating a state of a currently set type is stored in a nonvolatile storage unit, and
the control unit, in a case where the application is activated to display the UI screen, displays the UI screen corresponding to the information indicating the state of the currently set type stored in the storage unit.

9. The image forming apparatus according to claim 1, wherein
the control unit displays at least a portion of a background of the UI screen differently for each of the plurality of types.

10. The image forming apparatus according to claim 1, wherein
the setting unit, in a case where a user operation for pressing a predetermined tab included in the UI screen is performed, changes a currently set type to the other type.

11. The image forming apparatus according to claim 1, further comprising a scanner,
wherein the application is an application that executes a job for transmitting scanned image data obtained by the scanner scanning a document.

12. The image forming apparatus according to claim 1, wherein
the management unit, in a case where the user changes the setting value on the UI screen, updates the setting value associated with information on a type indicated on the UI screen into the changed setting value.

13. The image forming apparatus according to claim 1, wherein
job setting by the user is received without authenticating the user.

14. A method for controlling an image forming apparatus executing a job relating to image processing, the method comprising:
setting a UI screen corresponding to an application for executing the job so that the UI screen is in a state of a type selected by a user from a plurality of types;
in a case where the user changes a setting value on the UI screen in the state of the set type to execute the job, storing the changed setting value associated with information on the set type; and
in a case where a currently set type is changed to another type based on selection by the user, displaying the UI screen in a state of the other type using a setting value associated with information on the other type out of stored setting values.

15. A non-transitory computer readable storage medium storing a program which causes a computer to perform a method for controlling an image forming apparatus executing a job relating to image processing, the method comprising:
setting a UI screen corresponding to an application for executing the job so that the UI screen is in a state of a type selected by a user from a plurality of types;
in a case where the user changes a setting value on the UI screen in the state of the set type to execute the job, storing the changed setting value associated with information on the set type; and
in a case where a currently set type is changed to another type based on selection by the user, displaying the UI screen in a state of the other type using a setting value associated with information on the other type out of stored setting values.
